(19) United States
(12) Patent Application Publication
(10) Pub. No.: US 2004/0213555 A1
(43) Pub. Date: Oct. 28, 2004

(54) Apparatus and method for recording video data

(76) Inventors: Masayuki Nishimoto, Ome-shi (JP); Kiyoshi Hoshino, Ome-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/786,111

(22) Filed: Feb. 26, 2004

(30) Foreign Application Priority Data
Feb. 28, 2003 (JP) 2003-053817

(51) Int. Cl. H04N 5/76

(52) U.S. Cl. 386/95; 386/111

(57) ABSTRACT

A first encoder section and a second encoder section encode video data at different compression rates. The encoded data are recorded in different areas A and A′ of a large-capacity storage section, respectively. When reproduction on a monitor is instructed, a control section reproduces the video data recorded in the area A. On the other hand, when transfer to a mobile video data reproducing device is instructed, the control section transfers the video data recorded in the area A′ to the mobile video data reproducing device.

### CROSS-REFERENCE TO RELATED APPLICATIONS

This application is based upon and claims the benefit of priority from prior Japanese Patent Application No. 2003-053817, filed Feb. 28, 2003, the entire contents of which are incorporated herein by reference.

### BACKGROUND OF THE INVENTION

1. Field of the Invention

This invention relates to an apparatus compressing digital audio-visual data at different compression rates and recording the compressed data.

2. Description of the Related Art

Generally, when audio-visual data are recorded on a recording medium, the data are compressed. Encoding schemes of different compression rates are applied to the recording of the audio-visual data on a HDD (hard disk drive) and a DVD (digital versatile disk) and the recording on a CD or a memory card. Jpn. Pat. Appln. KOKAI Publication No. 2002-330401 discloses a technique of recording and reproducing the audio-visual data at optimum streaming schemes, on optical disks having different recording densities, respectively, in accordance with the kind of input signals or the image quality of the digital broadcast.

Conventionally, when the digital audio-visual data are recorded at a portable or what is called mobile video data reproducing device, for example, high-quality digital audio-visual data recorded on a recording medium having a large capacity such as a HDD of a PC (personal computer) is converted into high-compression audio-visual data and the converted data are recorded on the reproducing device. This is because the recording capacity cannot be freely increased in view of the goods characteristic that the mobile audio-visual data reproducing device needs to be small.

Generally, an information recording medium having a comparatively small recording capacity such as a memory card or the like is applied to the mobile video data reproducing device. For this reason, the low-quality and small-capacity audio-visual data are needed as the audio-visual data to be recorded, for the mobile video data reproducing device. On the other hand, when recording is executed by a recording device which is not designed to be portable, the audio-visual data is recorded as the high-quality and large-capacity data.

To transfer the audio-visual data to the mobile video data reproducing device, the time to reproduce the high-quality audio-visual data recorded on the recording medium at a real time or at least the time to convert the data into high-compression digital audio-visual data is required.

As described above, when the high-quality and large-capacity audio-visual data are transferred to the mobile video data reproducing device, conventionally, the data is transferred while converted into the low-quality and small-capacity audio-visual data. Thus, the time for conversion is required in addition to the time for transfer, and therefore much time is spent.

### BRIEF SUMMARY OF THE INVENTION

A video data recording apparatus according to one of embodiments of the present invention comprises a first encoder section encoding input video data at a first compression rate, a second encoder section encoding the input video data at a second compression rate, and a storage section storing the video data encoded by the first encoder section and the video data encoded by the first encoder section while associating the encoded video data with each other.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a structure of a recording and reproducing apparatus 100a according to an embodiment of the present invention;

FIG. 2 is a flow chart showing a recording operation of the recording and reproducing apparatus 100a;

FIG. 3 is a block diagram showing a structure of a recording and reproducing apparatus 100b according to a second embodiment of the present invention;

FIG. 4 is a flow chart showing a recording operation of the recording and reproducing apparatus 100b;

FIG. 5 is a block diagram showing a structure of a recording and reproducing apparatus 100c according to a third embodiment of the present invention;

FIG. 6 is a flow chart showing a modified example of a recording operation of the recording and reproducing apparatus 100c;

FIGS. 7A and 7B show management tables 10 managing a data file recorded in a storage section 4; and

FIG. 8 is a flow chart showing the processing of reproducing and transferring the data file recorded in the storage section 4.

### DETAILED DESCRIPTION OF THE INVENTION

Embodiments of the present invention will be described below with reference to the drawings.

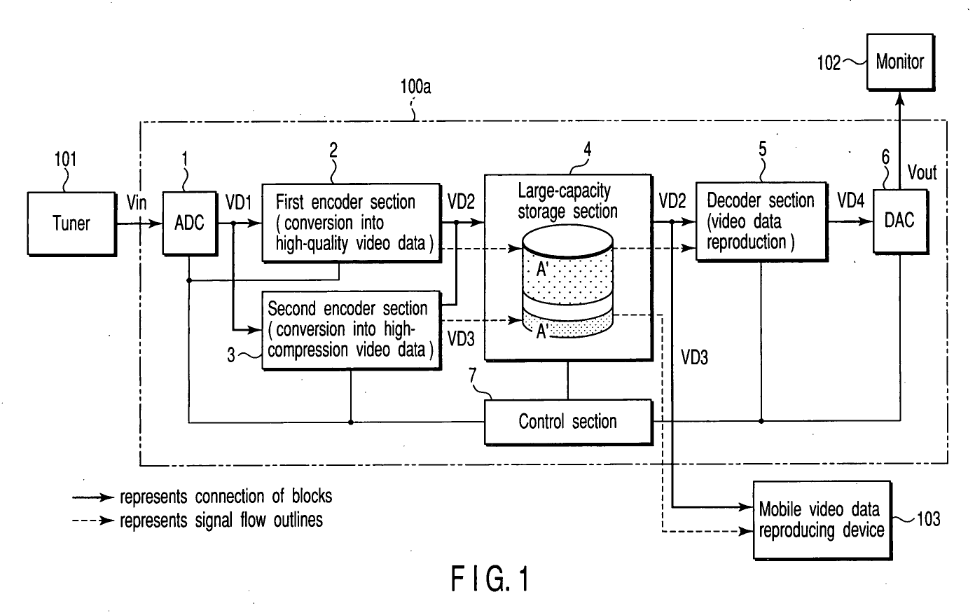

FIG. 1 is a block diagram showing a structure of a recording and reproducing apparatus 100a according to an embodiment of the present invention.

A control section 7 comprises a ROM storing a program according to the present invention, a CPU executing the program and a RAM utilized as a work area, and totally controls the apparatus 100a. The program may be stored in the large-capacity storage section 4, and expanded and executed in the RAM as occasion requires.

An audio-visual signal Vin received by a tuner 101 such as a TV tuner or the like is converted by an analog-digital converter (ADC) 1 into digital audio-visual data (hereinafter simply called video data) VD1, which is supplied to a first encoder 2 and a second encoder 3. The first encoder 2, converts the video data VD1 into high-quality video data VD2 by compressing (encoding) the video data VD1, and stores the data VD2 in an area A of the storage section 4. The first encoder 2 compresses the video data VD1 in, for example, MPEG2 scheme. The first encoder 2 also stores a content (program) obtained from conversion into the video data VD2, as a file (or a plurality of files if the data capacity is large), in the area A of the storage section 4. The storage section 4 is, for example, a HDD.

The second encoder 3 converts the data VD1 into high-compression video data VD3 by compressing the video data VD1 to the video data VD3 at high-compression ratio and, stores the video data VD3 in an area A′ of the storage section 4. The second encoder 3 compresses the video data VD1, for example, in the MPEG4 scheme. The second encoder 3 also stores one content obtained from conversion into the video data VD2, as a file (or a plurality of files if the data capacity is large), in the area A′ of the storage section 4.

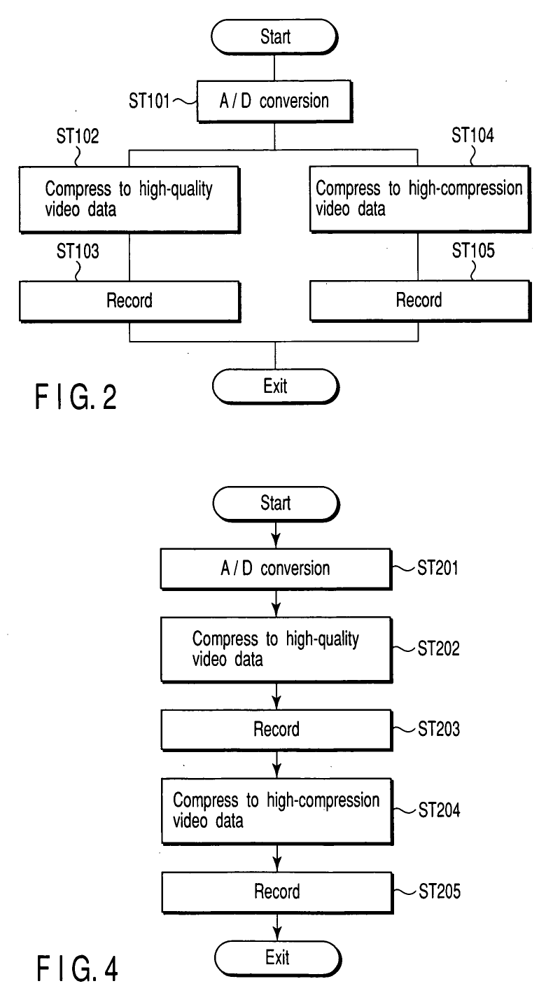

FIG. 2 is a flow chart showing a recording operation of the recording and reproducing apparatus 100a. The control section 7 allows the video signal Vin to be A/D-converted by the ADC1 as indicated at step ST101, and compresses and records the video data VD1 by a concurrent processing of the first encoder section 2 and the second encoder section 3 as indicated at steps ST102 to ST105.

A decoder section 5 decodes the video data VD2 stored in the area A of the storage section 4 and supplies decoded video data VD4 to a digital-analog converter (DAC) 6. The DAC 6 converts the video data VD4 into an analog video signal Vout. The video signal Vout is supplied to a monitor 102 of a TV monitor or the like, and the speech and video are thereby reproduced. The recording and reproducing apparatus of the present invention may comprise the tuner 101 and/or the monitor 102.

When the video data stored in the storage section 4 are reproduced with the image quality which is substantially the same as that of the original images, the control section 7 sequentially reads the video data stored in the area A by the decoder section 5. If the video data stored in the storage section 4 are reproduced by a mobile video data reproducing device 103 whose storage capacity is limited, the control section 7 transfers video data which is highly compressed in advance and which is stored in the area A′ to the reproducing device 103.

The reproducing device 103 is a portable video data reproducing device. The reproducing device comprises a memory card composed of a flush memory or the like which records the video data, a reproducing section which reproduces the recorded video data, a LCD which displays the video, and a loudspeaker or headphone which reproduces the speech.

Generally, the reproducing device is separated from a device which provides the video data when it is utilized. Thus, to record the video data, the entire video data of interest needs to be encoded or transferred. In this embodiment, however, the reproducing device 103 can be separated from the apparatus 100a and carried by only waiting for a short time to transfer the entire video data. The speech and video may be reproduced by inserting the memory card into the apparatus 100a, recording the highly compressed video data VD3 in the area A′ on the memory card, and inserting the memory card into the reproducing device.

As described above, according to this embodiment, the data are preliminarily compressed for the mobile device. When the video data are carried with the mobile device, it is necessary only to wait for a short time to transfer the data. Although both the high-quality and large-capacity files and low-quality and small-capacity files need to be stored in the recording and reproducing apparatus 100a, the capacity of the low-quality and small-capacity file is substantially one twentieth as large as that of the high-quality and large-capacity file, which depends on the degree and scheme of the file compression. It is therefore considered that the capacity of the storage section 4 is not wasted. Moreover, as the high-quality and large-capacity files are also stored, a desire of appreciating, copying and processing the files while they have high quality and large capacity can be satisfied.

Next, a second embodiment of the present invention will be described.

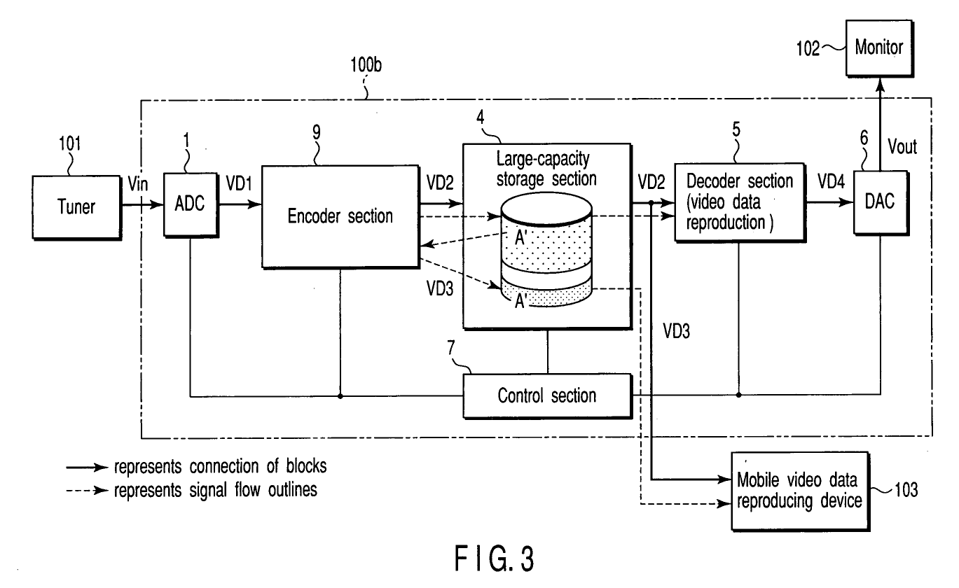

FIG. 3 is a block diagram showing a structure of a recording and reproducing apparatus 100b according to a second embodiment of the present invention.

In the recording and reproducing apparatus 100b, the first encoder 2 and the second encoder 3 of the recording and reproducing apparatus 100a are integrated as an encoder section 9. The encoder section 9 executes compression to the high-quality video data and compression to the high-compression data at different timings.

FIG. 4 is a flow chart showing a recording operation of the recording and reproducing apparatus 100b. The video data VD1 which is A/D-converted by the ADC 1 is compressed (encoded) in, for example, the MPEG2 scheme, to the high-quality video data VD2 by the encoder section 9. The high-quality video data VD2 is stored in the area A of the storage section 4 (ST201, ST202, ST203). Next, the encoder section 9 reads the video data VD2 stored in the area A, converts the video data into the high-compression video data VD3 in, for example, the MPEG4 scheme, and stores the video data VD3 in the area A′ of the storage section 4 (ST204, ST205).

According to the second embodiment, as described above, the vide data is stored in the storage section as the high-quality video data and then the conversion into the high-compression video data is executed. Thus, the encoder section 9 does not need to execute two kinds of compression at a real time, and a cheap apparatus can be provided.

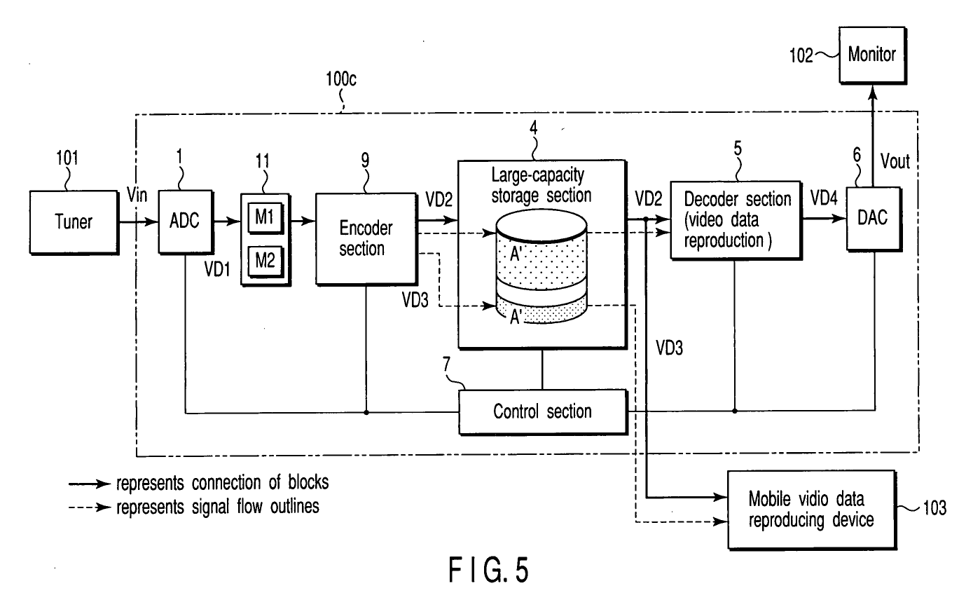

FIG. 5 is a block diagram showing a structure of a recording and reproducing apparatus 100c according to a third embodiment of the present invention.

In the recording and reproducing apparatus 100c, the first encoder 2 and the second encoder 3 of the recording and reproducing apparatus 100a are integrated as the encoder section 9, and an image memory 11 is provided.

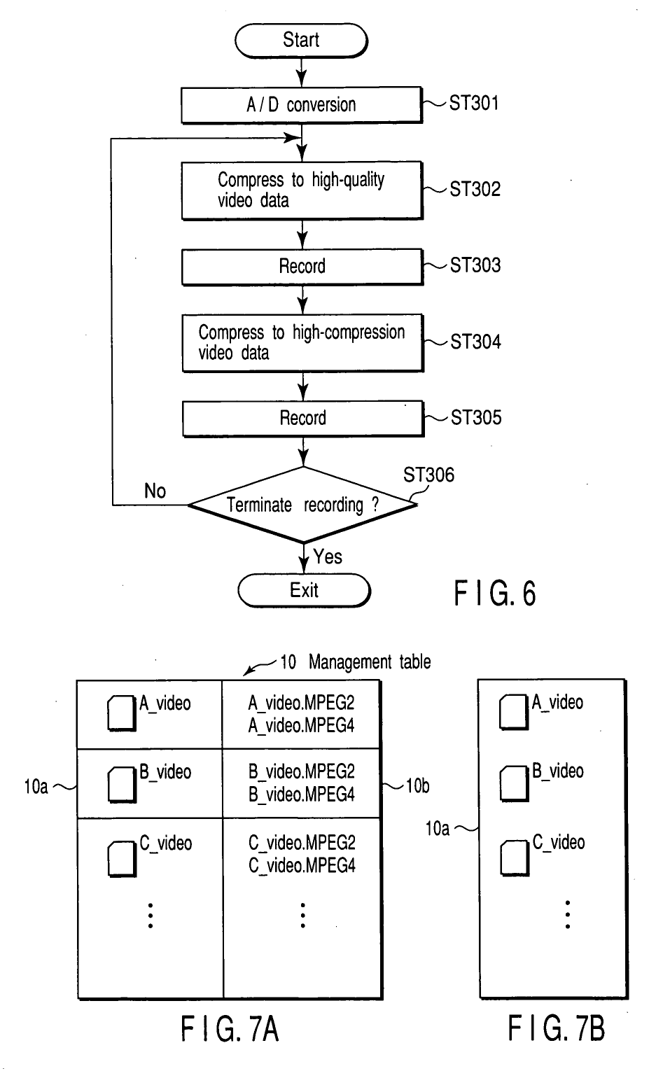

FIG. 6 is a flow chart showing a recording operation of the recording and reproducing apparatus 100c. The video data VD1 which is A/D-converted by the ADC1 is recorded by unit of a predetermined amount in area M1 and area M2, alternately, under control of the control section 7 until termination of the recording of one content.

The encoder section 9 first compresses (encodes) the video data recorded in the area M1 in, for example, the MPEG2 scheme, to the high-quality video data and stores the high-quality video data in the area A of the storage section 4 (ST302, ST303). Then, the encoder section 9 compresses the video data recorded in the area M1 in, for example, the MPEG4 scheme, to the high-compression video data and stores the high-compression video data in the area A′ of the storage section 4 (ST304, ST305).

It is discriminated whether the recording of the content is terminated or not, at step ST306. If the recording is not terminated, the flow returns to step ST302. The encoder section 9 compresses the video data recorded in the area M2 to the high-quality video data and stores the high-quality video data in the area A of the storage section 4 (ST302, ST303). Then, the encoder section 9 compresses the video data in the area M2 to the high-compression video data and stores the high-compression video data in the area A′ of the storage section 4 (ST304, ST305). Thus, the processings of steps ST302 to ST305 are repeated and the contents data which have the same contents with different compression rates are recorded in the storage section 4.

According to the third embodiment, as described above, the vide data is stored in the storage section as the high-quality video data and then the conversion into the high-compression video data is executed. Thus, the encoder section 9 does not need to execute two kinds of compression simultaneously and can compress the A/D-converted video data directly to the high-compression video data.

The encoder section 9 has been explained as hardware in the above-described embodiment. However, if the processing speed of the control section 7 is enough high, the encoder section 9 can be formed as software and further reduction of manufacturing costs of the apparatus can be expected.

Next, an embodiment of the recording and reproducing apparatus of the present invention will be described in relation to file management.

In the present invention, the high-quality video data and the high-compression video data having the same contents are recorded in the storage section. If they are handled separately, user operations are complicated. For this reason, a management table is formed such that they can be handled as the same data, in this embodiment.

FIG. 7 shows a management table 10 of contents recorded as video files in the storage section 4. The management table 10 comprises a table 10a and a table 10b as shown in FIG. 7A. If a list of the video files (contents) is displayed on the monitor 102, the management table 10a is displayed as the list as shown in FIG. 7B. The user instructs reproduction of the contents recorded in the storage section 4 or transfer of the contents to the mobile device by referring to the management table 10a.

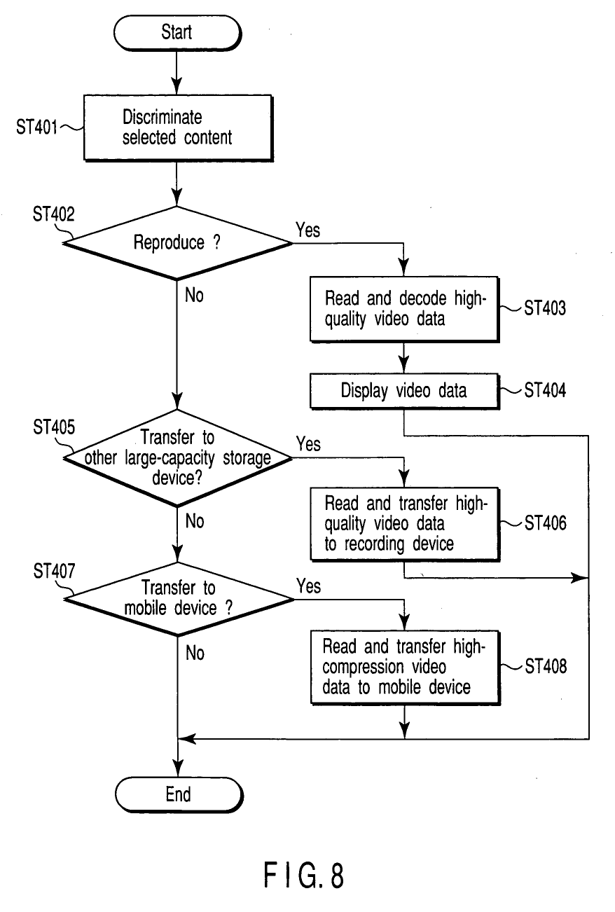

FIG. 8 is a flow chart showing the processings of reproducing and transferring the data file recorded in the storage section 4. The user selects the contents and supplies an instruction of reproduction, dubbing or the like to the control section 7 via an operation section (not shown) by referring to the management table 10a displayed on the monitor 102.

When the control section 7 receives an instruction from the user, the control section 7 discriminates the content selected by the user (“A_video”) as indicated at step ST401. Next, the control section 7 discriminates whether reproducing the video data on the monitor 102 is instructed (ST402). If the reproduction on the monitor 102 is instructed, the control section 7 reads the high-quality video data (A_video. MPEG2) recorded in the area A of the storage section, decodes the video data by the decoder section 5, converts the decoded video data into an analog signal by the DAC 6, and displays the analog signal on the monitor 102.

If dubbing to any other large-capacity storage section is instructed as indicated at step ST405, the control section 7 reads the high-quality video data (A_video. MPEG2) recorded in the area A of the storage section and transfers the video data to the other storage section as indicated at step ST406. The other storage section is a recording device (not shown) such as a DVD drive or the like, which is built in the apparatus or provided externally.

If the transfer to the mobile device is instructed as indicated at step ST407, the control section 7 reads the high-compression video data (A_video. MPEG4) recorded in the area A′ of the storage section and transfers the video data to the mobile device as indicated at step ST408.

By managing the data in the manner described above, the user can reproduce the video data or transfer it to the mobile device without considering which file is the high-compression video data or the high-quality video data. In other words, the operability of the apparatus can be improved.

According to other embodiment of the present invention, the high-quality and large-capacity data and the low-quality and small-capacity data can be formed as one file and the formed file can be shown logically as two files. If the content whose reproduction time is long is divided by unit of the data size or unit of the time due to the convenience of management or the like, a plurality of divided contents forming the one content are formed as one file.

That is, in a case of this scheme, if the user instructs display of the file list, the control section 7 displays the entire management table 10 of FIG. 7A or the table 10b on the monitor 102, allowing the user to select any file. For this reason, for example, high-compression video data can be transferred to the other large-capacity storage section.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video data recording apparatus comprising:
a first encoder section encoding input video data at a first compression rate;
a second encoder section encoding the input video data at a second compression rate; and
a storage section storing the video data encoded by the first encoder section and the video data encoded by the second encoder section while associating the encoded video data with each other.

2. The recording apparatus according to claim 1, further comprising:
a management section managing the video data stored in the storage section as video files; and
a transfer section transferring the video data compressed at the second compression rate to a mobile device when transfer of the video files to the mobile device is instructed.

3. The recording apparatus according to claim 1, further comprising:
a management section managing the video data stored in the storage section as video files; and
a transfer section transferring the video data compressed at the second compression rate to a memory card when transfer of the video files to the memory card is instructed.

4. The recording apparatus according to claim 1, further comprising:
a management section managing the video data stored in the storage section as video files;
a first display section displaying the video files of the video data of identical contents stored in the storage section, as a single file;
a second display section 10b displaying the video files of the video data of identical contents stored in the storage section, as different files; and
a section instructing any one of the first and second display sections to execute the displaying.

5. A method of recording video data, comprising:
encoding input video data at a first compression rate;
encoding the input video data at a second compression rate;
recording the video data encoded at the first compression rate and the second compression rate while associating the encoded video data with each other, ST205; and
transferring the video data encoded at the second compression rate to a mobile device when transfer to the mobile device is instructed.
